(19) United States
(12) Patent Application Publication
(10) Pub. No.: US 2025/0219958 A1
(43) Pub. Date: Jul. 3, 2025

(54) VIDEO STREAMING BITRATE ADAPTATION BASED ON CONGESTION DETECTION

(71) Applicant: RAKUTEN MOBILE, INC., Tokyo (JP)

(72) Inventor: Hamza Mohamed Lotfi BOUCHEBBAH, Tokyo (JP)

(73) Assignee: RAKUTEN MOBILE, INC., Tokyo (JP)

(21) Appl. No.: 18/399,045

(22) Filed: Dec. 28, 2023

(51) Int. Cl. H04L 47/263; H04L 47/12; H04L 47/2416

(52) U.S. Cl. CPC H04L 47/263; H04L 47/12; H04L 47/2416

(57) ABSTRACT

Provided are a method, system, and apparatus for adjusting the bitrate for video streaming may be provided. The method may include: determining whether there is network congestion for a packet based on whether a filtered cell quality indicator provided from a Media Access Control (MAC) Scheduler is lower than a cell quality indicator threshold value, based on whether a scheduling queue delay of a User Equipment (UE) is greater than a queue delay threshold value, or based on UE Assistance Information (UAI) reported by a user equipment (UE); based on a determination that there is network congestion: setting an explicit congestion notification (ECN) bit in an IP packet header and setting the congestion state of a user IP to true; sending the packet; and applying adaptive bitrate to adjust a quality of a video stream based on the congestion state

### 1. FIELD

Systems and methods consistent with example embodiments of the present disclosure relate to providing a method for adaptive bitrate for video streaming based on congestion detection in a network.

### 2. DESCRIPTION OF RELATED ART

A radio access network (RAN) is an important component in a telecommunications system, as it connects end-user devices (or user equipment (UE)) to other parts of the network. The RAN includes a combination of various network elements (NEs) that connect the end-user devices to a core network. Traditionally, hardware and/or software of a particular RAN is vendor specific.

Recently, the evolution of telco technologies enables many telco services to be realized virtually, in the form of software. For instance, RANs such as Open RAN (O-RAN) architectures, disaggregate one network component into multiple functional elements. By way of example, a baseband unit (BBU) or base station (i.e., eNB or gNB) is disaggregated into a number of functional elements including a distributed unit (DU) and a centralized unit (CU), wherein the CU can be further disaggregated into Centralized Unit-Control Plane (CU-CP) and Centralized Unit-User Plane (CU-UP). The disaggregation of network elements enables the telco services and the associated functions to be defined and provided in software-based form or virtual network services, such as Virtualized Network Functions (VNFs), Cloud-native Network Functions (CNFs) or Software Defined Networking (SDN), among others.

### SUMMARY

According to the related art, a UE which is connected to a RAN network may encounter network congestion while streaming video data. When such network congestion occurs, network performance can be affected in several ways. For example, the transmission of data packets may be delayed or disrupted, resulting in slow data transfer rates, lost packets, or increased latency. This can lead to poor network performance, reduced quality of service, and user frustration.

Accordingly, there is a need for a method which can enhance video quality (e.g., video bitrate) based on detected network congestion, as well as reducing the network congestion where possible.

According to embodiments, a method for adjusting the bitrate for video streaming may be provided. The method may include: determining whether there is network congestion for a packet based on whether a filtered cell quality indicator provided from a Media Access Control (MAC) Scheduler is lower than a cell quality indicator threshold value, based on whether a scheduling queue delay of a User Equipment (UE) is greater than a queue delay threshold value, or based on UE Assistance Information (UAI) reported by a user equipment (UE); based on a determination that there is network congestion: setting an explicit congestion notification (ECN) bit in an IP packet header and setting the congestion state of a user IP to true; sending the packet; and applying adaptive bitrate to adjust a quality of a video stream based on the congestion state. Accordingly, since the video bitrate/quality is adjusted directly based on the network congestion (RAN conditions, undesirable interruptions in video streaming (such as buffering) can be avoided, access time will be lowered, and overall network congestion can be reduced. Furthermore, the system can anticipate based on previously defined condition for detecting network congestion to ensure fast adaptation of the bitrate.

According to embodiments, an apparatus for adjusting the bitrate for video streaming may be provided. The apparatus may be configured to: determine whether there is network congestion for a packet based on whether a filtered cell quality indicator (CQI) provided from a Media Access Control (MAC) Scheduler is lower than a cell quality indicator threshold value, based on whether a RLC scheduling queue delay of a User Equipment (UE) is greater than a queue delay threshold value, or based on UE Assistance Information (UAI) reported by a user equipment (UE); based on a determination that there is network congestion: setting an explicit congestion notification (ECN) bit in an IP packet header and setting the congestion state of a user IP to true; send the packet; and apply adaptive bitrate to adjust a quality of a video stream based on the congestion state.

According to embodiments, a non-transitory computer-readable recording medium having recorded thereon instructions may be provided. The instructions may be executed to perform a method including: determining whether there is network congestion for a packet based on whether a filtered cell quality indicator (CQI) provided from a Media Access Control (MAC) Scheduler is lower than a cell quality indicator threshold value, based on whether a RLC scheduling queue delay of a User Equipment (UE) is greater than a queue delay threshold value, or based on UE Assistance Information (UAI) reported by a user equipment (UE); based on a determination that there is network congestion: setting an explicit congestion notification (ECN) bit in an IP packet header and setting the congestion state of a user IP to true; sending the packet; and applying adaptive bitrate to adjust a quality of a video stream based on the congestion state.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a system architecture diagram, according to an embodiment;

FIG. 2 illustrates a block diagram of a method for detecting a true congestion state and adapting a video bitrate based on CQI and queue delay according to an embodiment;

FIG. 3 illustrates a block diagram of a method for detecting a false congestion state and adapting a video bitrate based on CQI and queue delay, according to an embodiment;

FIG. 4 illustrates a block diagram of a method for detecting a true congestion state and adapting a video bitrate based on User Assistance Information (UAI);

FIG. 5 is a diagram of an example environment in which systems and/or methods, described herein, may be implemented; and

FIG. 6 is a diagram of example components of a device according to an embodiment.

### DETAILED DESCRIPTION

The following detailed description of example embodiments refers to the accompanying drawings.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Example embodiments of the present invention provide a method for adjusting the bitrate/video quality for video streaming for a user equipment (UE) in a RAN network. The method may include determining whether there is network congestion for a packet based on whether a filtered cell quality indicator (filtered CQI) provided from a Media Access Control (MAC) Scheduler is lower than a cell quality indicator threshold value or based on whether the RLC queue delay of a User Equipment (UE) is greater than a queue delay threshold value, or based on UE Assistance Information (UAI) reported by a user equipment (UE) (UAI may be as defined, for example, in 3GPP 138.331 V16 section 5.7.4);); based on a determination that there is network congestion: setting an explicit congestion notification (ECN) bit in an IP packet header and setting the congestion state of a user IP to true; sending the packet; and applying adaptive bitrate to adjust a quality of a video stream based on the congestion state. Accordingly, since the video bitrate/quality is adjusted directly based on the network congestion (RAN conditions, undesirable interruptions in video streaming (such as buffering) can be avoided, access time will be lowered, and overall network congestion can be reduced. Furthermore, the system can anticipate based on previously defined condition for detecting network congestion to ensure fast adaptation of the bitrate.

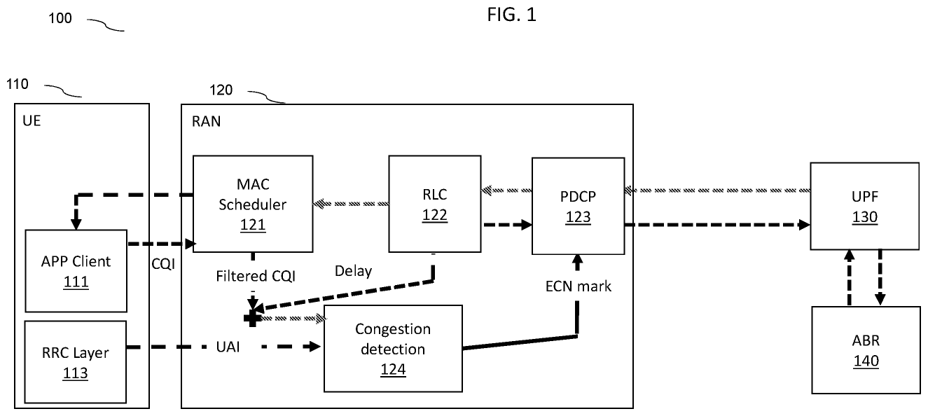

FIG. 1 illustrates a system architecture diagram of system 100, according to an embodiment.

Referring to FIG. 1, UE 110 may be provided, which is connected to RAN network 120. UE 110 may utilize an App Client 111 which provides a user service for requesting and transmitting data from UE 110 to RAN 120. According to some embodiments, App Client 111 may be a video streaming application, nevertheless, it should be appreciated that App Client 111 could be any application which includes providing video multimedia to the user from a server. UE 110 may send/report the cell quality indicator (CQI) to a MAC Scheduler 121 in RAN 120.

Radio Resource Control (RRC) Layer 113 is configured in UE 110. The RRC Layer 113 may transmit UE Assistance Information (UAI) to congestion detection module 124. UAI may indicate whether there is an overheating condition or power-saving condition for the network, and accordingly allow for the UAI to provide suggestions/indications to reduce bandwidth based on such conditions. It should be appreciated that other information may be included in UAI, depending on the specific implementation.

Medium Access Control (MAC) Scheduler 121 may be configured to schedule and allocate bandwidth resources to UE 110. Accordingly, MAC Scheduler 121 may also be configured to process the CQI reports received from App Client 111 and provide a filtered CQI (which may consist of an averaged CQI which has been exponentially filtered) to congestion detection module 124.

Radio link control (RLC) 122 may provide a queue delay value in downlink to the congestion detection module 124. The queue delay value may be a scheduling queue delay which indicates the delay of a RLC Protocol Data Unit (PDU). According to some embodiments, the queue delay value may also include any delay caused at the distributed unit (DU) and air interface latency latency.

Based on one or more of the filtered CQI and queue delay value, and UAI, the congestion detection module 124 may be able to determine whether there is a state of congestion or not. It should be appreciated that while the embodiments discussed herein specify whether there is a true or false state of congestion by using a single threshold value for comparison, multiple states (including numerical levels of congestion) can be detected according to other embodiments by using multiple threshold values for comparison.

Based on the determination by congestion detection module 124, the explicit congestion notification (ECN) bit in the IP header for the packet being sent from App Client 111 to Packet Data Convergence Protocol (PDCP) 123 may be set. It should be noted that if the version of IP being used is IPv4, that a checksum in uplink towards User Plane Function (UPF) 130 should be recalculated, for UE 110 (which is being scheduled in downlink).

UPF 130 may be in communication with an Adaptive Bitrate (ABR) module 140. In particular, based on the congestion state and the ECN bit received from congestion module 124 (via UPF 130), the ABR module may adjust the bitrate/quality. In principle, if there is congestion (e.g., a state of “true” or a higher numerical value of congestion), the bitrate or quality should be lowered and optimized in order to avoid unwanted stoppage or increased access time. In contrast, if there is little or no congestion (e.g., a state of “false” or a lower numerical value of congestion), the bitrate or quality can be increased in order to enhance the user's viewing experience. It should be appreciated that according to some embodiments, a particular bitrate may correspond to a specific video resolution. For example, 480p video may correspond to a bitrate range of 500-2000 Kbps, whereas 1080p video at 60 fps may correspond to a bitrate range of 4500-9000 KBps. Nevertheless, it should be appreciated that the specific correspondence between video quality/resolution (including framerate) and bitrate may be readily selected by one skilled in the art based on the specific implementation. The threshold values for setting the congestion state with congestion detection module 124 may be selected based on a corresponding desired video quality/bitrate

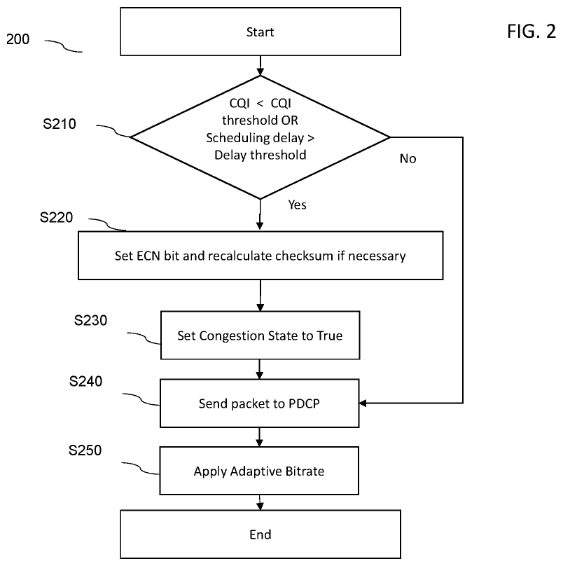

FIG. 2 illustrates a block diagram of a method 200 for detecting a true congestion state and adapting a video bitrate based on CQI and queue delay according to an embodiment. Method 200 may be implemented using a system architecture similar to that of system 100. Method 200 may be implemented for each packet that is being sent. According to embodiments, the packet may be a non-guaranteed bitrate bearer downlink TCP-QUIC packet

At operation S210, it may be determined as to whether the filtered CQI (e.g., the average CQI over a period of time and exponentially filtered) as provided by MAC scheduler 121 is lower than a threshold CQI value (e.g., the quality is low). It may also be determined as to whether the RLC queue delay value which indicates scheduling queue delay (e.g., between RLC 122 and MAC scheduler 121) is above a certain threshold queue delay value (e.g., the queue time is long). If either of these conditions are matched, then it may be determined that there is network congestion.

At operation S220, if it was determined that the result of operation S210 was “yes”, an ECN bit in the IP header for the packet is set to indicate the congestion. As mentioned above, if the version of IP being used is IPv4, a checksum in uplink towards UPF 130 should be recalculated, for UE 110 (which is being scheduled in downlink).

At operation S230, which may be performed following operation S220, the congestion state for the user IP may be set to “true”. Nevertheless, it may be appreciated that according to some embodiments, different values may be set depending on the specific level of congestion.

At operation S240, which may be performed either following operation S230, or if the result of the determination in operation S210 was “no”, the packet may be sent to PDCP (e.g., PDCP 123).

At operation S250, which may be performed following operation S240, adaptive bitrate (ABR) is performed based on the ECN bit and congestion state (which may have been set in operations S220 and S230). If congestion has occurred or increased, then the bitrate/video quality may be lowered relative to the current values (e.g., by throttling in order to reduce the bitrate). In other words, an ECN feedback loop may be used for setting the bitrate/video quality of the video content.

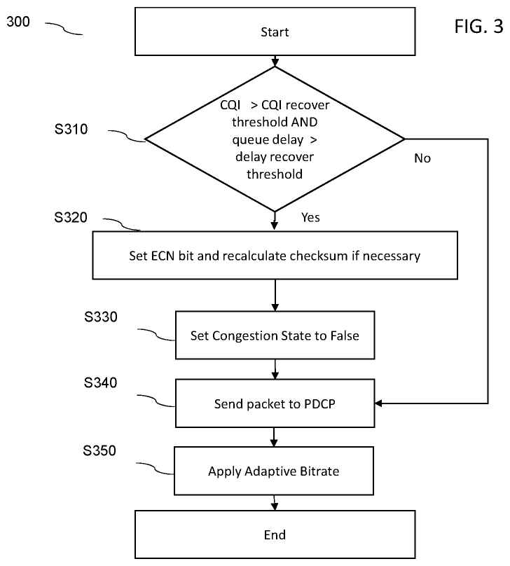

FIG. 3 illustrates a block diagram of method 300 for detecting a false congestion state and adapting a video bitrate based on CQI and queue delay, according to an embodiment. Method 300 may be implemented using a system architecture similar to that of system 100. Method 300 may be sequentially performed after method 200 according to an embodiment. Method 300 may be implemented for each packet that is being sent. According to embodiments, the packet may be a non-guaranteed bitrate bearer downlink TCP-QUIC packet

At operation S310, it may be determined as to whether the filtered CQI (e.g., the average CQI over a period of time and exponentially filtered) as provided by MAC scheduler 121 is greater than a threshold recovery CQI value (e.g., the quality is low). It may also be determined as to whether the queue delay value which indicates scheduling queue delay (e.g., between RLC 122 and MAC scheduler 121) is above a certain threshold queue delay recovery value (e.g., the queue time is now low). If both of these conditions are matched, then it may be determined that there is no longer any network congestion.

At operation S320, if it was determined that the result of operation S310 was “yes”, an ECN bit in the IP header for the packet is set to indicate there is no longer any congestion. As mentioned above, if the version of IP being used is IPv4, a checksum in uplink towards UPF 130 should be recalculated, for UE 110 (which is being scheduled in downlink).

At operation S330, which may be performed following operation S320, the congestion state for the user IP may be set to “false”. Nevertheless, it may be appreciated that according to some embodiments, different values may be set depending on the specific level of congestion.

At operation S340, which may be performed either following operation S330, or if the result of the determination in operation S310 was “no”, the packet may be sent to PDCP (e.g., PDCP 123).

At operation S350, which may be performed following operation S340, adaptive bitrate (ABR) is performed based on the ECN bit and congestion state (which may have been set in operations S320 and S330). If congestion has decreased or is no longer present, then the bitrate/video quality may be increased relative to the current values. In other words, an ECN feedback loop may be used for setting the bitrate/video quality of the video content.

It should be appreciated that while the illustrated embodiments discuss using both queue delay and CQI, that these two parameters may be used separately according to other embodiments. Nevertheless, it should be noted that using queue delay and CQI may allow for adaptive behavior of the method/system based on congestion (for example, in case of the user moving towards a cell edge or if there is limited RF conditions, it is ensured that the packet indicates there is congestion).

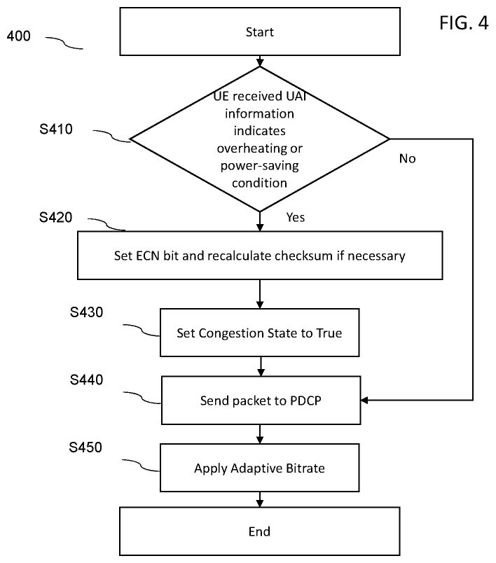

FIG. 4 illustrates a block diagram of a method for detecting a true congestion state and adapting a video bitrate based on User Assistance Information (UAI);

Method 400 may be implemented using a system architecture similar to that of system 100. Method 400 may be implemented for each packet that is being sent. According to embodiments, the packet may be a non-guaranteed bitrate bearer downlink TCP-QUIC packet

At operation S410, it may be determined as to whether the UAI (e.g., received from RRC Layer 113 with reference to FIG. 1) indicates either a power-saving condition or an overheating condition. UAI may be as defined, for example, in 3GPP 138.331 V16 section 5.7.4. If either is present, it may be determined that there is network congestion. It should be appreciated that depending on the specific information from the UAI, other conditions for indicating network congestion may be possible.

At operation S420, if it was determined that the result of operation S410 was “yes”, an ECN bit in the IP header for the packet is set to indicate the congestion. As mentioned above, if the version of IP being used is IPv4, a checksum in uplink towards UPF 130 should be recalculated, for UE 110 (which is being scheduled in downlink).

At operation S430, which may be performed following operation S420, the congestion state for the user IP may be set to “true”. Nevertheless, it may be appreciated that according to some embodiments, different values may be set depending on the specific level of congestion.

At operation S440, which may be performed either following operation S430, or if the result of the determination in operation S410 was “no”, the packet may be sent to PDCP (e.g., PDCP 123).

At operation S450, which may be performed following operation S540, adaptive bitrate (ABR) is performed based on the ECN bit and congestion state (which may have been set in operations S420 and S430). If congestion has occurred or increased, then the bitrate/video quality may be lowered relative to the current values (e.g., by throttling in order to reduce the bitrate). In other words, an ECN feedback loop may be used for setting the bitrate/video quality of the video content.

The above embodiments can accordingly provide a method and device for adjusting video quality/bitrate directly based on the network congestion (RF) conditions, undesirable interruptions in video streaming (such as buffering) can be avoided, access time will be lowered, and overall network congestion can be reduced. Furthermore, the system can anticipate based on the ECN mark and queue delay for detecting network congestion to ensure fast adaptation of the bitrate.

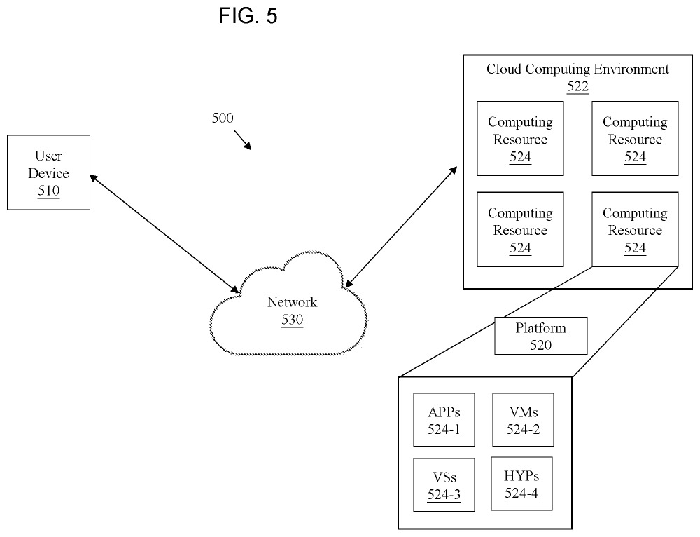

FIG. 5 is a diagram of an example environment 500 in which systems and/or methods, described herein, may be implemented. As shown in FIG. 5, environment 500 may include a user device 510, a platform 520, and a network 530. Devices of environment 500 may interconnect via wired connections, wireless connections, or a combination of wired and wireless connections. In embodiments, any of the functions and operations described with reference to FIGS. 1 through 4 above may be performed by any combination of elements illustrated in FIG. 5.

User device 510 includes one or more devices capable of receiving, generating, storing, processing, and/or providing information associated with platform 520. For example, user device 510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 510 may receive information from and/or transmit information to platform 520.

Platform 520 includes one or more devices capable of receiving, generating, storing, processing, and/or providing information. In some implementations, platform 520 may include a cloud server or a group of cloud servers. In some implementations, platform 520 may be designed to be modular such that certain software components may be swapped in or out depending on a particular need. As such, platform 520 may be easily and/or quickly reconfigured for different uses.

In some implementations, as shown, platform 520 may be hosted in cloud computing environment 522. Notably, while implementations described herein describe platform 520 as being hosted in cloud computing environment 522, in some implementations, platform 520 may not be cloud-based (i.e., may be implemented outside of a cloud computing environment) or may be partially cloud-based.

Cloud computing environment 522 includes an environment that hosts platform 520. Cloud computing environment 522 may provide computation, software, data access, storage, etc., services that do not require end-user (e.g., user device 510) knowledge of a physical location and configuration of system(s) and/or device(s) that hosts platform 520. As shown, cloud computing environment 522 may include a group of computing resources 524 (referred to collectively as “computing resources 524” and individually as “computing resource 524”).

Computing resource 524 includes one or more personal computers, a cluster of computing devices, workstation computers, server devices, or other types of computation and/or communication devices. In some implementations, computing resource 524 may host platform 520. The cloud resources may include compute instances executing in computing resource 524, storage devices provided in computing resource 524, data transfer devices provided by computing resource 524, etc. In some implementations, computing resource 524 may communicate with other computing resources 524 via wired connections, wireless connections, or a combination of wired and wireless connections.

As further shown in FIG. 5, computing resource 524 includes a group of cloud resources, such as one or more applications (“APPs”) 524-1, one or more virtual machines (“VMs”) 524-2, virtualized storage (“VSs”) 524-3, one or more hypervisors (“HYPs”) 524-4, or the like.

Application 524-1 includes one or more software applications that may be provided to or accessed by user device 510. Application 524-1 may eliminate a need to install and execute the software applications on user device 510. For example, application 524-1 may include software associated with platform 520 and/or any other software capable of being provided via cloud computing environment 522. In some implementations, one application 524-1 may send/receive information to/from one or more other applications 524-1, via virtual machine 524-2.

Virtual machine 524-2 includes a software implementation of a machine (e.g., a computer) that executes programs like a physical machine. Virtual machine 524-2 may be either a system virtual machine or a process virtual machine, depending upon use and degree of correspondence to any real machine by virtual machine 524-2. A system virtual machine may provide a complete system platform that supports execution of a complete operating system (“OS”). A process virtual machine may execute a single program, and may support a single process. In some implementations, virtual machine 524-2 may execute on behalf of a user (e.g., user device 510), and may manage infrastructure of cloud computing environment 522, such as data management, synchronization, or long-duration data transfers.

Virtualized storage 524-3 includes one or more storage systems and/or one or more devices that use virtualization techniques within the storage systems or devices of computing resource 524. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 524-4 may provide hardware virtualization techniques that allow multiple operating systems (e.g., “guest operating systems”) to execute concurrently on a host computer, such as computing resource 524. Hypervisor 524-4 may present a virtual operating platform to the guest operating systems, and may manage the execution of the guest operating systems. Multiple instances of a variety of operating systems may share virtualized hardware resources.

Network 530 includes one or more wired and/or wireless networks. For example, network 530 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

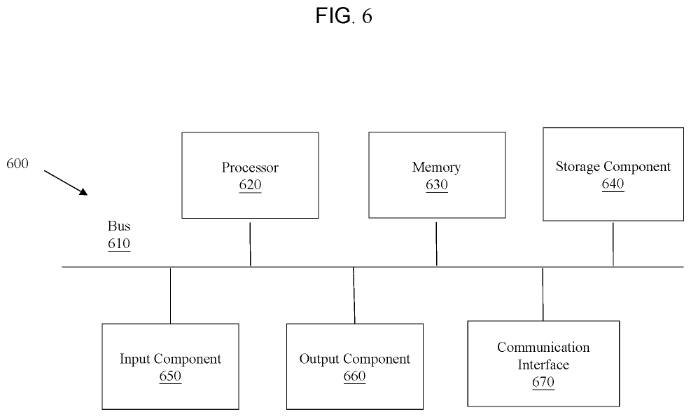

FIG. 6 is a diagram of example components of a device 600. Device 600 may correspond to user device 510 and/or platform 520. As shown in FIG. 6, device 600 may include a bus 610, a processor 620, a memory 630, a storage component 640, an input component 650, an output component 660, and a communication interface 670.

Bus 610 includes a component that permits communication among the components of device 600. Processor 620 may be implemented in hardware, firmware, or a combination of hardware and software. Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 includes one or more processors capable of being programmed to perform a function. Memory 630 includes a random access memory (RAM), a read only memory (ROM), and/or another type of dynamic or static storage device (e.g., a flash memory, a magnetic memory, and/or an optical memory) that stores information and/or instructions for use by processor 620.

Storage component 640 stores information and/or software related to the operation and use of device 600. For example, storage component 640 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 650 includes a component that permits device 600 to receive information, such as via user input (e.g., a touch screen display, a keyboard, a keypad, a mouse, a button, a switch, and/or a microphone). Additionally, or alternatively, input component 650 may include a sensor for sensing information (e.g., a global positioning system (GPS) component, an accelerometer, a gyroscope, and/or an actuator). Output component 660 includes a component that provides output information from device 600 (e.g., a display, a speaker, and/or one or more light-emitting diodes (LEDs)).

Communication interface 670 includes a transceiver-like component (e.g., a transceiver and/or a separate receiver and transmitter) that enables device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

Device 600 may perform one or more processes described herein. Device 600 may perform these processes in response to processor 620 executing software instructions stored by a non-transitory computer-readable medium, such as memory 630 and/or storage component 640. A computer-readable medium is defined herein as a non-transitory memory device. A memory device includes memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

In embodiments, any one of the operations or processes of FIGS. 1-4 may be implemented by or using any one of the elements illustrated in FIGS. 5 and 6. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

### Various Aspects of Embodiments

Various further respective aspects and features of embodiments of the present disclosure may be defined by the following items:

Item [1] A method for adjusting the bitrate for video streaming, the method including: determining whether there is network congestion for a packet based on whether a filtered cell quality indicator provided from a Media Access Control (MAC) Scheduler is lower than a cell quality indicator threshold value, based on whether a scheduling queue delay of a User Equipment (UE) is greater than a queue delay threshold value, or based on UE Assistance Information (UAI) reported by a user equipment (UE); based on a determination that there is network congestion: setting an explicit congestion notification (ECN) bit in an IP packet header and setting the congestion state of a user IP to true; sending the packet; and applying adaptive bitrate to adjust a quality of a video stream based on the congestion state.
Item [2]: The method according to item [1]: wherein the packet is a non-guaranteed bitrate bearer downlink TCP-QUIC packet, and the packet is sent to Packet Data Convergence Protocol (PDCP).
Item [3]: The method according to any one of items [1]-[2]: wherein the IP packet header is IPV4, and wherein based on a determination that there is network congestion, the method further comprises recalculating a checksum in uplink towards a carrier grade network address translator (CGNAT) for the UE which is scheduled for downlink.
Item [4]: The method according to any one of items [1]-[3]: wherein the method further includes: determining whether there is no longer network congestion for the packet based on whether the filtered CQI is greater than a cell quality recovery threshold value; based on a determination that there is no longer network congestion: setting the ECN bit in the IP packet header; and setting the congestion state of the user IP to false; sending the packet; and applying adaptive bitrate to adjust the quality of the video stream based on the congestion state.
Item [5]: The method according to item [4]: wherein determining whether there is no longer network congestion for the packet is further based on whether a scheduling queue delay of the UE is greater than a queue delay recovery threshold value.
Item [6]: The method according to item [4]: wherein determining whether there is no longer network congestion for the packet is further based on UAI reported by the UE.
Item [7]: The method according to item [4]: wherein the IP packet header is IPV4, and wherein based on a determination that there is no longer network congestion, the method further includes recalculating a checksum in uplink towards a user plane function (UPF) for the UE which is scheduled for downlink.
Item [8]: An apparatus for adjusting the bitrate for video streaming, the apparatus configured to: determine whether there is network congestion for a packet based on whether a filtered cell quality indicator (CQI) provided from a Media Access Control (MAC) Scheduler is lower than a cell quality indicator threshold value, based on whether a RLC scheduling queue delay of a User Equipment (UE) is greater than a queue delay threshold value, or based on UE Assistance Information (UAI) reported by a user equipment (UE); based on a determination that there is network congestion: setting an explicit congestion notification (ECN) bit in an IP packet header and setting the congestion state of a user IP to true; send the packet; and apply adaptive bitrate to adjust a quality of a video stream based on the congestion state.
Item [9]: The apparatus according to item [8]: wherein the packet is a non-guaranteed bitrate bearer downlink TCP-QUIC packet, and the packet is sent to Packet Data Convergence Protocol (PDCP).
Item [10]: The apparatus according to any one of items [8]-[9], wherein the IP packet header is IPV4, and wherein based on a determination that there is network congestion, the apparatus is further configured to recalculate a checksum in uplink towards a carrier grade network address translator (CGNAT) for the UE which is scheduled for downlink.
Item [11]: The apparatus according to any one of items [8]-[10]: wherein the apparatus is further configured to: determine whether there is no longer network congestion for the packet based on whether the filtered CQI is greater than a cell quality recovery threshold value; based on a determination that there is no longer network congestion: setting the ECN bit in the IP packet header; and setting the congestion state of the user IP to false; send the packet; and apply adaptive bitrate to adjust the quality of the video stream based on the congestion state.
Item [12]: The apparatus according to item [11]: wherein determining whether there is no longer network congestion for the packet is further based on whether a scheduling queue delay of the UE is greater than a queue delay recovery threshold value.
Item [13]: The apparatus according to item [11]: wherein determining whether there is no longer network congestion for the packet is further based on UAI reported by the UE.
Item [14]: The apparatus according to item [11]: wherein the IP packet header is IPV4, and wherein based on a determination that there is no longer network congestion, the apparatus is further configured to recalculate a checksum in uplink towards a user plane function (UPF) for the UE which is scheduled for downlink.
Item [15]: A non-transitory computer-readable recording medium having recorded thereon instructions to perform a method including: determining whether there is network congestion for a packet based on whether a filtered cell quality indicator (CQI) provided from a Media Access Control (MAC) Scheduler is lower than a cell quality indicator threshold value, based on whether a RLC scheduling queue delay of a User Equipment (UE) is greater than a queue delay threshold value, or based on UE Assistance Information (UAI) reported by a user equipment (UE); based on a determination that there is network congestion: setting an explicit congestion notification (ECN) bit in an IP packet header and setting the congestion state of a user IP to true; sending the packet; and applying adaptive bitrate to adjust a quality of a video stream based on the congestion state.
Item [16]: The non-transitory computer-readable recording medium according to item [15]: wherein the packet is a non-guaranteed bitrate bearer downlink TCP-QUIC packet, and the packet is sent to Packet Data Convergence Protocol (PDCP).
Item [17]: The non-transitory computer-readable recording medium according to any one of items [15]-[16]: wherein the IP packet header is IPV4, and wherein based on a determination that there is network congestion, the method further includes recalculating a checksum in uplink towards a carrier grade network address translator (CGNAT) for the UE which is scheduled for downlink.
Item [18]: The non-transitory computer-readable recording medium according to any one of items [15]-[17], wherein the method further includes: determining whether there is no longer network congestion for the packet based on whether the filtered CQI is greater than a cell quality recovery threshold value; based on a determination that there is no longer network congestion: setting the ECN bit in the IP packet header; and setting the congestion state of the user IP to false; sending the packet; and applying adaptive bitrate to adjust the quality of the video stream based on the congestion state.
Item [19]: The non-transitory computer-readable recording medium according to item [18], wherein determining whether there is no longer network congestion for the packet is further based on whether a scheduling queue delay of the UE is greater than a queue delay recovery threshold value.
Item [20]. The non-transitory computer-readable recording medium according to item [18], wherein determining whether there is no longer network congestion for the packet is further based on UAI reported by the UE.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method for adjusting the bitrate for video streaming, the method comprising:
determining whether there is network congestion for a packet based on whether a filtered cell quality indicator (CQI) provided from a Media Access Control (MAC) Scheduler is lower than a cell quality indicator threshold value, based on whether a RLC scheduling queue delay of a User Equipment (UE) is greater than a queue delay threshold value, or based on UE Assistance Information (UAI) reported by a user equipment (UE);
based on a determination that there is network congestion:
setting an explicit congestion notification (ECN) bit in an IP packet header and
setting the congestion state of a user IP to true;
sending the packet; and
applying adaptive bitrate to adjust a quality of a video stream based on the congestion state.

2. The method of claim 1, wherein the packet is a non-guaranteed bitrate bearer downlink TCP-QUIC packet, and the packet is sent to Packet Data Convergence Protocol (PDCP).

3. The method of claim 1, wherein the IP packet header is IPV4, and wherein based on a determination that there is network congestion, the method further comprises recalculating a checksum in uplink towards a carrier grade network address translator (CGNAT) for the UE which is scheduled for downlink.

4. The method of claim 1, wherein the method further comprises:
determining whether there is no longer network congestion for the packet based on whether the filtered CQI is greater than a cell quality recovery threshold value;
based on a determination that there is no longer network congestion:
setting the ECN bit in the IP packet header; and
setting the congestion state of the user IP to false;
sending the packet; and
applying adaptive bitrate to adjust the quality of the video stream based on the congestion state.

5. The method of claim 4, wherein determining whether there is no longer network congestion for the packet is further based on whether a scheduling queue delay of the UE is greater than a queue delay recovery threshold value.

6. The method of claim 4, wherein determining whether there is no longer network congestion for the packet is further based on UAI reported by the UE.

7. The method of claim 4, wherein the IP packet header is IPV4, and wherein based on a determination that there is no longer network congestion, the method further comprises recalculating a checksum in uplink towards a user plane function (UPF) for the UE which is scheduled for downlink.

8. An apparatus for adjusting the bitrate for video streaming, the apparatus configured to:
determine whether there is network congestion for a packet based on whether a filtered cell quality indicator (CQI) provided from a Media Access Control (MAC) Scheduler is lower than a cell quality indicator threshold value, based on whether a RLC scheduling queue delay of a User Equipment (UE) is greater than a queue delay threshold value, or based on UE Assistance Information (UAI) reported by a user equipment (UE);
based on a determination that there is network congestion:
setting an explicit congestion notification (ECN) bit in an IP packet header and
setting the congestion state of a user IP to true;
send the packet; and
apply adaptive bitrate to adjust a quality of a video stream based on the congestion state.

9. The apparatus of claim 8, wherein the packet is a non-guaranteed bitrate bearer downlink TCP-QUIC packet, and the packet is sent to Packet Data Convergence Protocol (PDCP).

10. The apparatus of claim 8, wherein the IP packet header is IPV4, and wherein based on a determination that there is network congestion, the apparatus is further configured to recalculate a checksum in uplink towards a carrier grade network address translator (CGNAT) for the UE which is scheduled for downlink.

11. The apparatus of claim 8, wherein the apparatus is further configured to:
determine whether there is no longer network congestion for the packet based on whether the filtered CQI is greater than a cell quality recovery threshold value;
based on a determination that there is no longer network congestion:
setting the ECN bit in the IP packet header; and
setting the congestion state of the user IP to false;
send the packet; and
apply adaptive bitrate to adjust the quality of the video stream based on the congestion state.

12. The apparatus of claim 11, wherein determining whether there is no longer network congestion for the packet is further based on whether a scheduling queue delay of the UE is greater than a queue delay recovery threshold value.

13. The apparatus of claim 11, wherein determining whether there is no longer network congestion for the packet is further based on UAI reported by the UE.

14. The method of claim 11, wherein the IP packet header is IPV4, and wherein based on a determination that there is no longer network congestion, the apparatus is further configured to recalculate a checksum in uplink towards a user plane function (UPF) for the UE which is scheduled for downlink.

15. A non-transitory computer-readable recording medium having recorded thereon instructions to perform a method comprising:
determining whether there is network congestion for a packet based on whether a filtered cell quality indicator (CQI) provided from a Media Access Control (MAC) Scheduler is lower than a cell quality indicator threshold value, based on whether a RLC scheduling queue delay of a User Equipment (UE) is greater than a queue delay threshold value, or based on UE Assistance Information (UAI) reported by a user equipment (UE);
based on a determination that there is network congestion:
setting an explicit congestion notification (ECN) bit in an IP packet header and
setting the congestion state of a user IP to true;
sending the packet; and
applying adaptive bitrate to adjust a quality of a video stream based on the congestion state.

16. The non-transitory computer-readable recording medium of claim 15, wherein the packet is a non-guaranteed bitrate bearer downlink TCP-QUIC packet, and the packet is sent to Packet Data Convergence Protocol (PDCP).

17. The non-transitory computer-readable recording medium of claim 15, wherein the IP packet header is IPV4, and wherein based on a determination that there is network congestion, the method further comprises recalculating a checksum in uplink towards a carrier grade network address translator (CGNAT) for the UE which is scheduled for downlink.

18. The non-transitory computer-readable recording medium of claim 15, wherein the method further comprises:
determining whether there is no longer network congestion for the packet based on whether the filtered CQI is greater than a cell quality recovery threshold value;
based on a determination that there is no longer network congestion:
setting the ECN bit in the IP packet header; and
setting the congestion state of the user IP to false;
sending the packet; and
applying adaptive bitrate to adjust the quality of the video stream based on the congestion state.

19. The non-transitory computer-readable recording medium of claim 18, wherein determining whether there is no longer network congestion for the packet is further based on whether a scheduling queue delay of the UE is greater than a queue delay recovery threshold value.

20. The non-transitory computer-readable recording medium of claim 18, wherein determining whether there is no longer network congestion for the packet is further based on UAI reported by the UE.
